(19) United States
(12) Patent Application Publication
(10) Pub. No.: US 2005/0217237 A1
(43) Pub. Date: Oct. 6, 2005

(54) Thrust, with or without the ejection of propellant

(76) Inventor: Everett Wade Willett, Chicago, IL (US)

Correspondence Address: Everett W. Willett, P. O. Box 805464, Chicago, IL, 60680, US

(21) Appl. No.: 10/962,824

(22) Filed: Oct. 8, 2004

Related U.S. Application Data
(60) Provisional application No. 60/510,600, filed on Oct. 10, 2003.

(51) Int. Cl. F02K 1/00

(52) U.S. Cl. 60/200.1; 60/204

(57) ABSTRACT

Thrust, with or without the ejection of propellant in a vehicle by an arrangement of levitating masses or a levitating mass and operating method are provided for achieving economical fuel consumption. The invention comprises a method of producing forward thrust, aft thrust, a hovering position, control around the yaw, roll, and pitch axis by an arrangement of levitating masses or a levitating mass within the vehicles structure. The produced propellant may be manufactured from existing. technology such as a marine jet engine, jet engine, turbo fan engine, a solid propellant engine or a liquid propellant engine. The propellant may also be produced by proposed propulsion systems such as, an electric ion engine, a nuclear fission engine, a plasma fusion engine, a photon engine or an anti-matter engine. The levitation system can be designed from existing technology such as an electromagnet apparatus, a super conducting magnetic apparatus or the levitating mass can be completely self supported, that is, the repelling force that holds the levitating mass within a stationary position comes from within the levitating mass. The reaction of accumulated propellant pressure trapped between the levitating mass, the hollow passage-way, the propellant gate and the propellant producing engine exert a repelling force against the vehicle's structure, thus propelling the engine and the vehicle in which it is mounted.

### CROSS-REFERENCE TO RELATED APPLICATION

This application claims the benefit of the provisional patent application # 60/510,600 file date Oct. 10, 2003

### FEDERALLY SOPONSORED REASEARCH

Not Applicable

### BACKGROUND OF THE INVENTION

1. Field of the Invention

The present invention relates to thrust, with or without the ejection of propellant by an arrangement of levitating masses, or a levitation mass, and methods for the production of such levitating masses, and for controlling such levitating masses for propelling a vehicle.

2. Prior Art

Aerospace propulsion technology to date has rested firmly on the applications of the reaction principal, creating motion by expelling propellant mass from a vehicle. In present day vehicle propulsion systems the use of expelled propellant by a engine to produce a large amount of thrust necessarily to facilitate the transition of a vehicle is known. The term“thrust” is defined to mean the amount of propulsive force developed by a propulsion engine. It is desirable to have the ratio of thrust produce to the rate of consumption of fuel to be as high as possible and this is generally referred to as“specific impulse”. In a vehicle's propulsion system having a high“specific impulse” capability is highly desirable.

It is known in the art of expelled propellant by an engine to produce thrust that are capable of providing the thrust necessary to lift payloads from the earth's surface was achieved with the development of rocket engines. The efficiency of a rocket motor is measured by a formula that compares what goes into the motor, with what comes out. The output is thrust, generally measured by pounds. The input is fuel and oxidizer, having a certain rate and is measured in pounds per second. If output is divided by input—that is—thrust (pounds) divided by propellant flow (pounds per second) the pounds cancel each other, and we are left with seconds, as the unit of merit for the motor. This number is called specific impulse or, ISP. The higher the ISP, the better, as far as propulsive efficiency is concerned. Unfortunately rocket engines consume huge quantities of propellant that must be stored on board the vehicle. In order to launch even relatively small payloads, the size of the rocket-propelled launch vehicle must be enormous in order to contain all of the propellant.

It is known in the art of expelled propellant by an engine, to produce thrust that are capable of providing the thrust necessary to lift payloads from the earth's surface was achieved with the development of the jet and turbo-fan engine. It is well known in the field of transportation that the jet and turbo fan engine have impacted the transportation industry respectfully. Jet engine technology have been in existence since the 1930's, and have probably reached their zenith in efficient fuel consumption. There are disclosures of propulsion systems that generate propulsive forces with out the ejection of propellant. One such application is magneto-hydrodynamic propulsion system, which ionized the medium within the vehicle. For example U.S. Pat. No 5,211,006 discloses a magneto-hydrodynamic propulsion system that is believed to be theoretically operative but is not a practical system because the system is environmentally disadvantageous because, it employs magnetic fields pulsating into the internal atmosphere, within the vehicle.

The difference between the prior art and my remarkable invention is, that the prior art ionized the medium within the vehicle, and the proposed invention traps the propellant inside the vehicle. It has also been suggested to use fluctuations in electrical components to induce stationary forces. These fluctuations are said to generate propulsive forces without the ejection of propellant. U.S. Pat. No. 5,280,864, U.S. Pat. No. 6,098,924 and, U.S. Pat. No. 6,347,766. These prior art disclosures exist in theory mathematical computation and scale models, and to date have no practical use.

The difference between the prior art and my extraordinary invention is that the prior art manipulates electrical signals in a magnetic field, and the proposed invention seals off the escape of propellant.

An innovative propulsion system having a high specific impulse is to make engines that accelerated without the expulsion of any material whatsoever or the minute explosion of propellant or by-product is realized.

It's apparent that great increases in fuel efficiency may be achieved through the application, Thrust, with or without the ejection of propellant, the subject of the present invention.

### BRIEF SUMMARY OF THE INVENTION

The primary objective of the present invention is to significantly reduce the fuel consumption of propellant producing engines and possible proposed propellant producing engines. The present invention relates to a vehicle for marine usage, (surface or underwater) outer space or in the atmosphere of the earth. The present invention avoids the drawbacks of prior art which consumes vast quantities of fuel. Within the present invention extreme propellant mass and extreme propellant pressure are contained and stabilized between the levitating mass, the hollow passage-way, the engine and engine parts. The propellant producing engine is throttled back at this time to approximately ten to twenty percent of the engines capabilities, thus decreasing the rate of fuel consumption. The propellant producing engine is throttled forward as need be, maintaining a constant extreme pressure of propellant and propellant mass, thus providing an efficient means of fuel consumption. Another objective of the present invention is to significantly reduce the decibel levels produced by current propellant producing engines and possibly proposed propellant producing engines.

In carrying out the present invention propellant is trapped between the levitating mass, the engine nacelle or (hallow passage-way) and the propellant producing engine and engine parts. As a consequence, little or no propellant escapes from the vehicle's structure. Thus the audio signature or decibel levels of the propellant producing engine are drastically reduced. A further objective of the present invention is to deplete the expulsion of harmful exhaust gasses and by-products produced by current propellant producing engines or possibly proposed propellant producing engines, which gradually destroy the ozone layer. In accordance with the present invention, propellant is prevented from escaping the vehicle's structure and is trapped between the hallow passageway, propellant producing engines and levitating mass, thus decreasing the amount of harmful exhaust gasses released into the surrounding medium. Still another objective of the present invention is to significantly reduce the downdraft of air when the present invention's configuration corresponds to a helicopter or vehicle's with vertical takeoff or landing (VTOL) characteristics. This will be appreciated when the balanced arrangement of levitated masses are placed within the vehicle's structure at calculated vertical axis which traps extreme propellant pressure and extreme propellant mass between it and the hallow passage-ways, the propellant producing engine and engine parts, thus little or no downdraft of propellant escapes from the vehicle.

Another aspect of the present invention is to significantly reduce the harmful conditions of exhaust blast to humans, created by current propellant producing engines or possible proposed propellant producing engines. Exploiting the present inventions distinctive traits, preventing escape of produced propellant, with the placement of the levitating mass toward the end of the propellant producing engines, nacelle, or hollow passageway, little or no exhaust blast is created.

A further aspect of the current invention contributes into calculating proposed or existing commercial, private or military airports landmasses. These new innovative decisions would greatly reduce the area of land mass needed, currently imposed by today's airports external form. This again will be appreciated when the levitating mass of the present invention traps extreme propellant mass and extreme propellant pressure between the balance arrangement of vertical axis within the vehicle's structure, thus the vehicle's transition from a static position to a forward motion or perpendicular angles of movement.

It is an object of the invention to provide a levitating mass for trapping a propellant which is used to propel a vehicle.

It is a further object of the invention to provide a levitating mass for imparting momentum to a vehicle by trapping propellant, which increases propellant pressure, thus transmitting in predetermined directions massive quantities of force.

It is still a further object of the invention to provide a levitating mass for imparting momentum to a vehicle, by preventing passage of the propellant into the medium surrounding the vehicle. Wherein powerful propellant forces are fist produced by the selected propellant producing engine and trapped in the engine nacelle or (hollow-passageway) by the levitating mass in accordance with the trapped propellant. Propellant pressure rises and is propelled in forward direction against the engine and engine parts, resulting in a reaction upon the engine, due to the transmission of exerted force opposing the levitation mass, thus providing thrust to the vehicle. Further objectives and advantages or the present invention will become apparent from considerations of the drawing and ensuing descriptions.

### DRAWINGS

FIG. 1 is a basic example, cross sectional view of a levitating mass, a hollow passage-way and a electromagnet.

FIG. 2 is also a basic example, cross sectional view of a levitating mass, a hollow passageway and electromagnet.

FIG. 3 is a basic example, partial cross section view of a hollow passage-way and a propellant gate.

FIG. 4 is a basic example, partial cross section view of a hollow passage-way and a propellant producing engine.

FIG. 5 is a basic example, side elevation view (starboard) side of a vehicle.

FIG. 6 is a basic example, side elevation view (port) side of a vehicle.

FIG. 7 is a basic example, top and end perspective view of a vehicle.

FIG. 9 is a basic example, bottom and end perspective view of a vehicle.

FIG. 10 is a basic example, top and front perspective view of a vehicle.

FIG. 11 is a basic example, partial cross sectional view of a self supporting levitating mass, propellant, propellant channels, propellant exhaust ports, variable electronic detector, integrator, computer electronic system, and propellant channel gates, propellant mass exhaust ports.

FIG. 12 is a basic example, diagrammatic sectional view with portions of the hull removed so as to expose the computer control system for the electromagnet, propellant gate, propellant producing engine and computer control for vehicle's movement, the view also reveals vehicle's supporting systems, crews life supporting systems, vehicle's weight supporting apparatus, payload and energy source for electromagnet.

FIG. 14 is a basic example, partial side cross sectional view within the vehicle's structure of the propellant producing engine, hollow passage-way, propellant gate and levitating mass.

FIG. 16 is a basic example, diagrammatic sectional view depicting the remote control computer system and crew compartment with in the vehicle's structure.

FIG. 17 is a basic example, partial top cross sectional view depicting the hollow passage-ways and propellant gates within the vehicle structure.

FIG. 19 is a basic example, partial cross sectional view, depicting the electromagnet, the transformer and the variable electronic detector.

FIG. 20 is a basic example, partial top cross sectional view depicting one propellant producing engine, one hollow passage-way, one propellant gate and one levitating mass within the vehicle's structure.

FIG. 21 is a basic example partial top cross sectional view within the vehicle's structure of more than one propellant producing engine, more than one hollow passage-way, more than one propellant gate, and more than one levitating mass.

### DETAILED DISCRIPTION

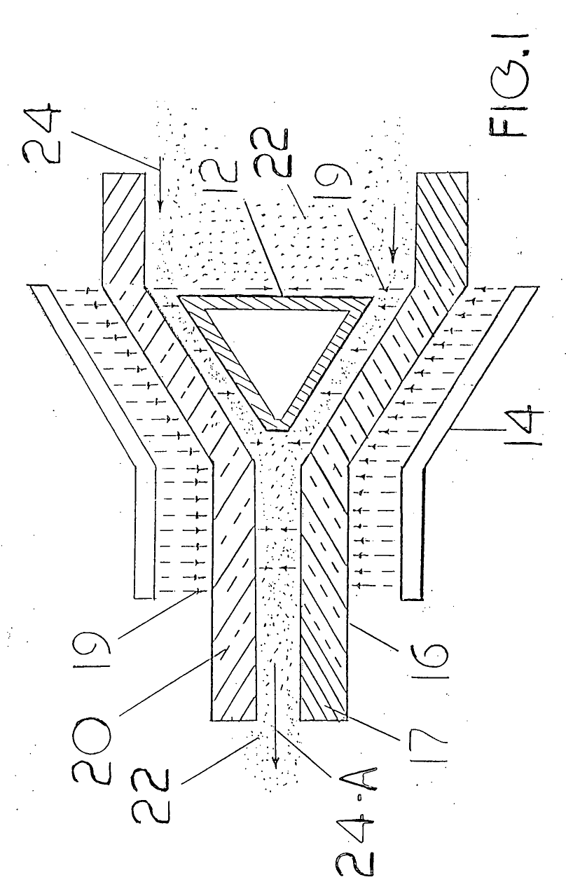

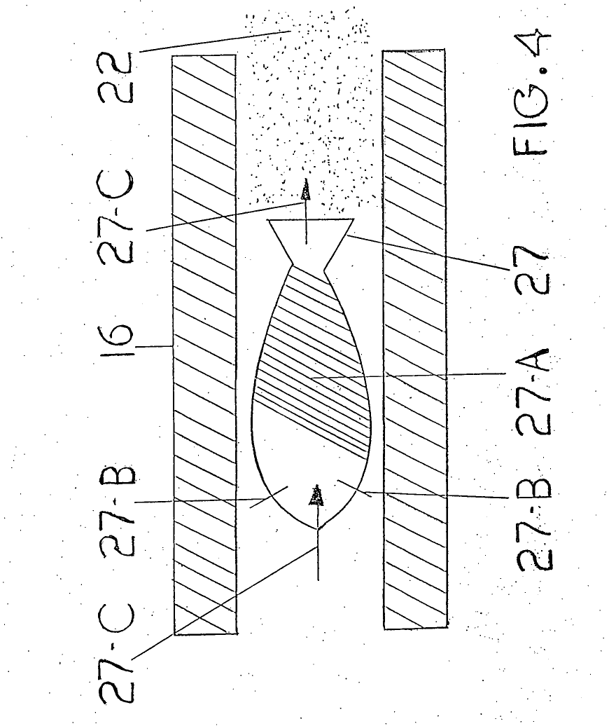

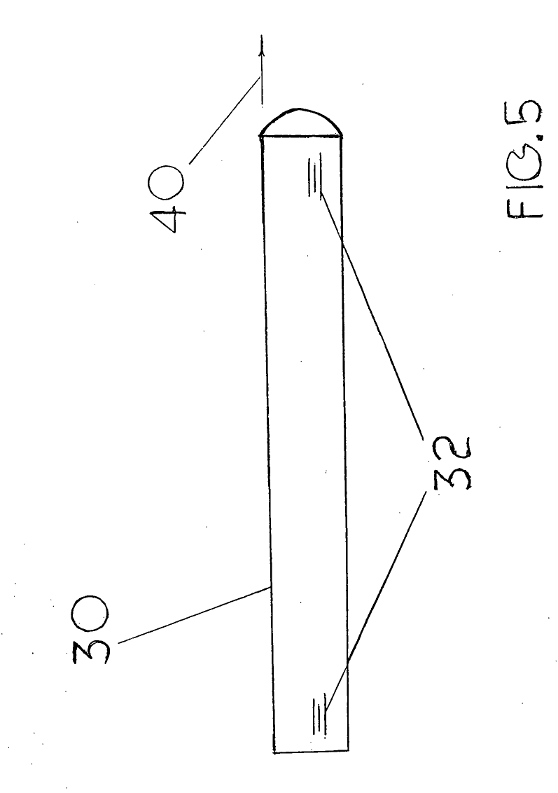

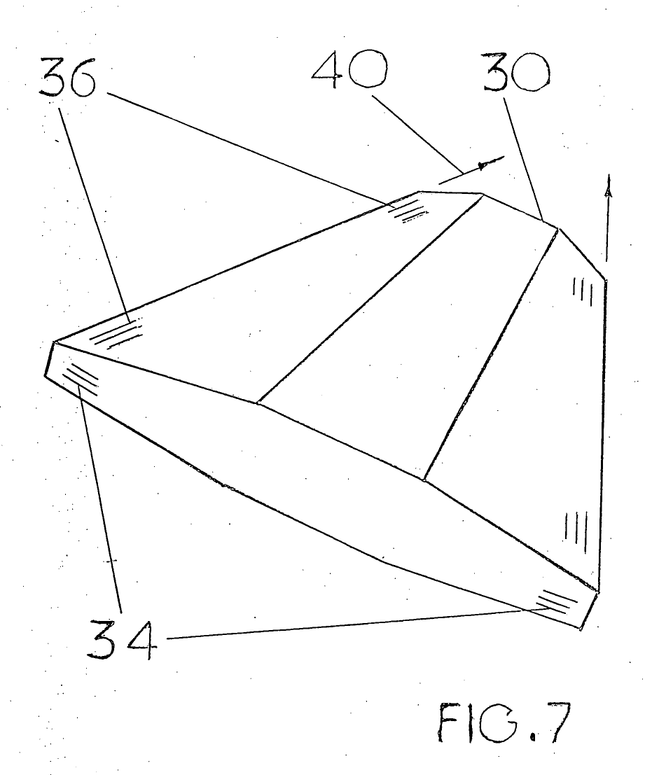

FIG. 1 is merely illustrative, as there are numerous variations and modifications, which may be made throughout the description. FIG. 1 is a basic example, partial cross sectional view of a levitating mass 12. The levitating mass 12 could be, but not necessarily designed in a circular configuration. The levitating mass or levitating masses 12 reside within the hollow passage-way 16 or hollow passage-ways 16 at predetermined locations to gain the most favorable results in affecting the vehicle's transition. The levitating mass 12 or levitating masses 12 comprise the composition 12-B repulsive to the maximum and minimum thermal range of accumulated propellant 22 pressure trapped between it, the hollow passage-way 16 and the propellant producing engine 27 FIG. 4. The levitating mass 12 or levitating masses 12 also comprise the composition 12-B to oppose the maximum propulsive pressure of the accumulated propellant 22 trapped between the hollow passageway 16 and the propellant producing engine 27 FIG. 4. The levitating mass or levitating masses additionally comprise the compositions 12-B responsive to the magnetic field energies 19, produced, induced, and directed by the electromagnet 14. The levitating mass 12 or levitating masses 12 levitate or hover in a contact less manner within the hollow passageway 16 at predetermined locations. The levitating mass 12 also comprise the composition 12-B repulsive to the mechanical magnetic field energy pressure 19 which are also produced, induced and directed by the electromagnet 14. The levitating mass 12 comprise a external contoured surface 12-A which mate the internal contoured surface 16-A of the hollow passageway 16 at predetermined locations. The levitating mass 12 can be used in a multitude of applications and environments, such as, marine, earth atmosphere or outer space. The levitating mass 12 maybe applied as a single application or multiple levitating masses 12 in arrangement. The levitating mass 12 represents the heart of this invention. The placement of the hollow passage-way 16 is arranged to facilitate the movement of propellant 22, toward the levitating mass 12. FIG. 1 also depicts a hollow passage-way. The hollow passage-way 16 within the vehicle's 30 structure comprise a composition 17 to withstand the maximum and minimum thermal range of accumulated propellant pressure 22 trapped between the levitating mass 12 and the propellant producing engine 27 FIG. 4. The hollow passage-way 16 comprise a composition 17 to withstand the maximum, propulsive pressure of accumulated propellant 22. FIG. 1 also depicts a hollow passage-way 16. The hollow passage-way 16 or hollow passage-ways 16 could be but not necessarily designed in a circular configuration. The hollow passageway 16 or hollow passage-way 16 reside within the vehicle's 30 structure at predetermined locations. The hollow passageway 16 maybe applied as a single application or multiple hollow passage-ways 16 in arrangement. The placement of the hollow passage-way 16 is arranged to facilitate the movement of propellant 22 toward the levitating mass 12. The hollow passage-way 16 in the vehicle's 30 structure comprised a composition 17 to withstand the maximum and minimum thermal range of accumulated propellant 22 pressure trapped between the levitating mass 12 and the propellant producing engine 27. The hollow passageway 16 at predetermined locations comprise a composition 20 transparent to the magnetic field energies 19 produced by the electromagnet 14. The hollow passageway 16 also comprise a composition 20 repulsive to the mechanical magnetic field pressure 19 which are also produced and induced by the electromagnet 14. The hollow passageway 16 or hollow passage-way 16 are arranged in the vehicle's 30 structure FIG. 7 to direct movement of the propellant 22 toward the levitating mass 12 to induce the vehicle's 30 movement or stationary attitude. The vehicle's 30 movement maybe in a forward direction in an aft or rearward direction or control around the vehicle's yaw, pitch and roll axis and a hovering position. The hollow passage-way are relative to the vehicle's 30 application. For example, if the vehicle 30 was designed only to be propelled in a forward direction by the levitating mass 12, the hollow passage-way 16 maybe constructed toward the rear of the vehicle 30. The hollow passage-way 16 at predetermined locations comprise an internal contoured surface 16-A which mate the levitating mass 12 external contoured surface 12-A. These mating surfaces correspond to the most favorable results toward thrust with or without the ejection or propellant. FIG. 1 further depicts an electromagnet 14; the electromagnet 14 could be, but not necessarily designed in a circular configuration. The electromagnet 14 in FIG. 1 surrounds the hollow passageway 16 a predetermined locations, in accordance with the levitating mass 12. The electromagnet 14 could be but not necessarily designed for human controllable input. The electromagnet 14 composition would endure the surrounding environment, maintained continuous exemplary operation, opposed mechanical subjective erosion, have connecting power supply and computer control operations. The levitating apparatus could be designed from electromagnets. The levitating apparatus could also be designed from a super conductor device. In FIG. 1 the propellant 22 flows 24 through the hollow passage-ways 16 between the external surface of the levitating mass 12-A and the internal surface of the hollow passage-way 16-A. The propellant 22 also continues flowing pass the levitating mass 12 in the hollow passageway 16 in the direction 24-A to corresponding exhaust ports 32, 34, 36, 39, FIG. 5, 6, 7, 9 and 10. The electromagnet 14 exert magnetic field energies which influence and maintain the levitating mass 12 stationary position.

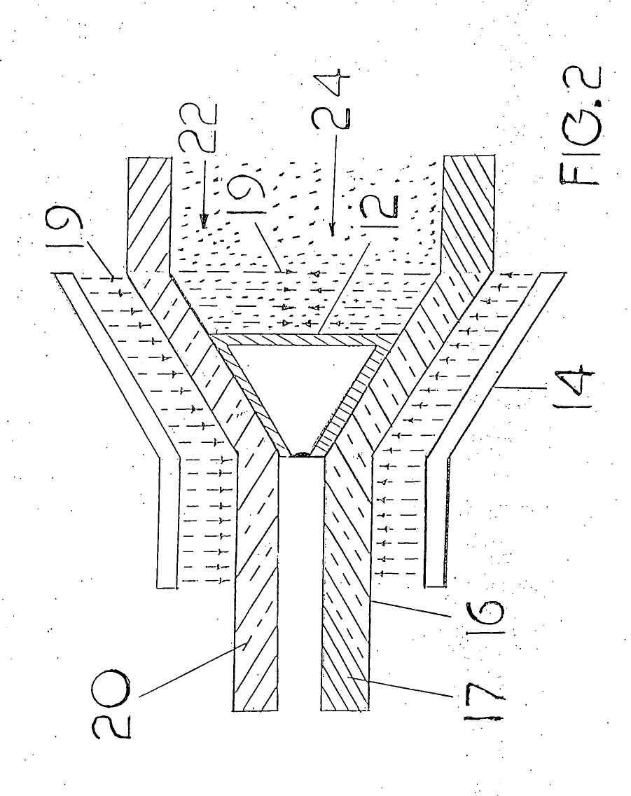

FIG. 2 Is merely illustrative, as there are numerous variations and modifications that maybe made throughout the description. FIG. 2 and FIG. 1 are identical except for two descriptions, the first description that is different is that the external surface 12-A of the levitating mass 12 are almost flush against the internal surface 16-A of the hollow passage-way 16. That is these two surfaces 12-A and 16-A could be within one hundredth of an inch, one thousandth or an inch or one millionth of an inch of contact. The second description that is different is that the propellant 22 is completely impeded, and does not flow past the levitated mass 12. This descriptions represents thrust, without the ejection of propellant.

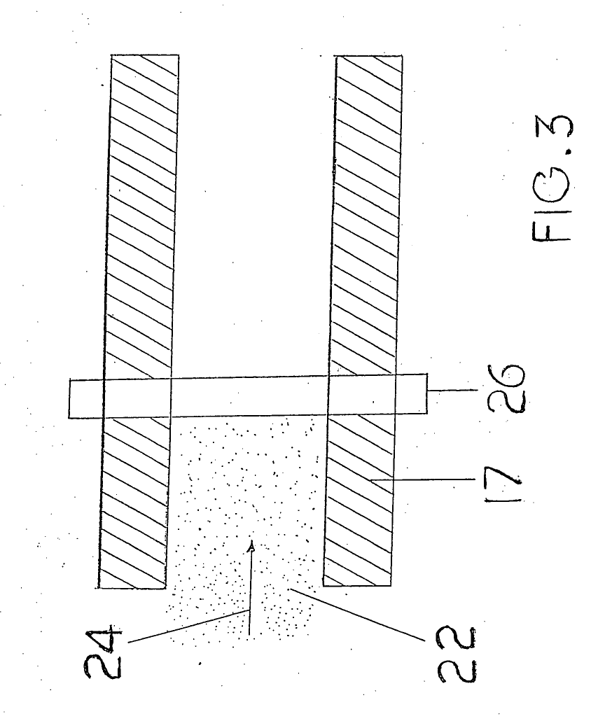

FIG. 3. Is merely illustrative, as there are numerous variations and modifications that maybe made throughout the description. FIG. 3 is a basic example, a partial cross sectional view of a hollow passageway 16 and a propellant gate 26. Since the hollow passageway 16 has already been described I will move on to the propellant gate. The propellant gate 26 comprise a composition to withstand the maximum and minimum thermal range of accumulated propellant 22, trapped between the propellant gate and the propellant producing engine 27, or the levitating mass 12 and the propellant gate 26 when the propellant gate 26 are in a closed position. The propellant gate 26 also comprise a composition to withstand the maximum compulsive pressure or accumulated propellant 22, trapped between the propellant producing engine 27 and the propellant gate 26 when the propellant gate 26 is in a closed position or the levitating mass 12 and the propellant gate 26 when the propellant gate 26 is in a closed position. The propellant gate 26 is strategically positions in the hollow passage-way 16 to gain the most favorable results of the propulsive accumulated propellant 22 trapped in corresponding hollow passage-way 16. The propellant gate 26 is also strategically positioned within the hollow passageway 16 in conjunction with corresponding propellant gate 26 arrangements and variable propellant 22 release. The propellant gate 26 could be but not necessarily designed for a human controllable input. The propellant gate has a controllable variable input, thus regulating the release of propellant 22. The propellant gate control system has a energy source.

FIG. 4 is merely illustrative, as there are numerous variations and modifications that may be made throughout the description. FIG. 4 is a basic example; a partial cross sectional view of a hollow passage-way 16 and a propellant producing engine 27. Since the hollow passage-way 16 has already been described, I'll move on to the propellant producing engine. The propellant producing engine 27 is strategically positioned in the vehicle's structure 30 to gain the most favorable results toward transmission of the propellant 22 throughout the hollow passageway 16, toward the levitating mass 12. The propellant producing engine 27, may be arranged to balance the vehicle 30 equilibrium in transition, or the vehicle 30 stationary attitude. The propellant producing engine 27 and engine parts comprise a composition to withstand the maximum and minimum thermal range of the accumulated propellant 22 trapped between the levitating mass 12 and the propellant producing engine 27, and the propellant gate 26 and the propellant producing engine 27. The propellant producing engine 27 and the engine parts comprise a composition to oppose the maximum pressure of the accumulated propellant trapped between the levitating mass 12 and the propellant engine 27 also the propellant gate 26 and the propellant producing engine 27. The propellant producing engine 27 maybe but not necessarily have a human input to a variable propellant control source. The propellant producing engine 27 would be connected to a fuel source and necessary hardware to maintain operation. The propellant producing engine 27 has a computer control system. The propellant producing engine 27 maybe designed for a multitude of applications and environments. Numeral 27-A represents a solid rocket engine, 27-B represents a liquid fuel rocket engine numeral 27-C represents a jet engine. The propellant producing engine 27 may also be designed from propulsion systems such as electric ions, nuclear fission, plasma fusion, photon or possibly an anti-matter engine. The propellant producing engine 27 will have to be designed in a new and futuristic way, and also designed at higher tolerances and specifications to oppose new and destructive environments towards engine parts.

FIG. 5 Is merely illustrative, as there are numerous variations and modifications that maybe made throughout the description. FIG. 5 is a basic example, side view (starboard side) or right side of the vehicle. Numeral 32 represents exhaust propellant yaw ports. The view depicts two exhausts propellant yaw ports 32. The vehicle 30 may have one exhaust yaw port starboard side, or no exhaust propellant yaw ports 32. An example of the vehicle 30 with no exhaust propellant yaw ports would be thrust without the ejection of propellant 22. The exhaust propellant yaw port may be but not necessarily, placed in the vehicle 30 structure in conjunction with the propellant flow direction 24-A in FIG. 1. Numeral 30 represents the vehicle. Numeral 40 represents the forward direction of the vehicle.

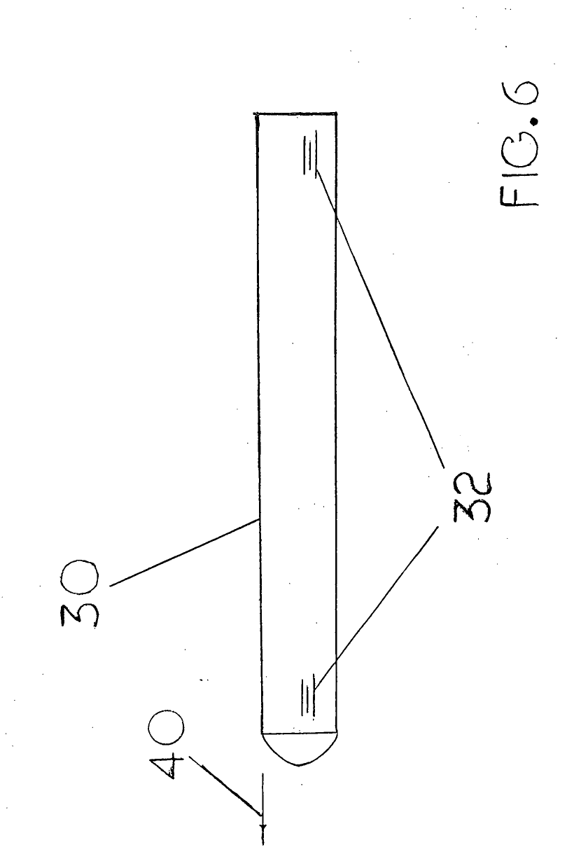

FIG. 6 Is merely illustrative, as there are numerous variations and modifications that maybe made throughout the description. FIG. 6 is a basic example side view (port) or left side of a vehicle 30, numeral 32 represents exhaust propellant yaw ports. The view depicts two exhaust propellant yaw ports 32, the vehicle 30 may have one exhaust propellant yaw ports 32 port side of the vehicle 30, or no exhaust propellant yaw ports 32. An example of the vehicle 30 with no exhaust propellant yaw ports 32 would be thrust, without the ejection of propellant 32. The exhaust propellant yaw port 32 maybe, but are not necessarily placed in the vehicle's 30 structure in conjunction with the propellant flow direction 24-A in FIG. 1. Numeral 30 represents the hull of the vehicle 30. Numeral 40 represents the forward direction of the vehicle 30.

FIG. 7 Is merely illustrative, as there are numerous variations and modifications that may be made throughout the description. FIG. 7 is a basic example, top and rear perspective view of a vehicle 30. The view depicts two exhaust propellant forward thrust exhaust propellant ports 34. The vehicle 30 may have only one exhaust propellant forward thrust port 34, or no exhaust propellant forward thrust ports 34. An example of the vehicle 30 with no exhaust propellant forward thrust ports 34, would be thrust without the ejection of propellant 22. The view also depicts four exhaust propellant roll pitch and hovering ports 36. The vehicle 30 may have two exhaust propellant roll pitch and hovering ports 36 or no exhaust propellant roll pitch and hovering ports 36. An example of a vehicle 30 with no exhaust propellant roll pitch and hovering ports 36 would be thrust without the ejection of propellant 22. The exhaust propellant roll pitch and hovering ports 36 maybe but not necessarily placed in the vehicle's 30 structure in conjunction with the propellant 22 flow directions 24-A in FIG. 1.

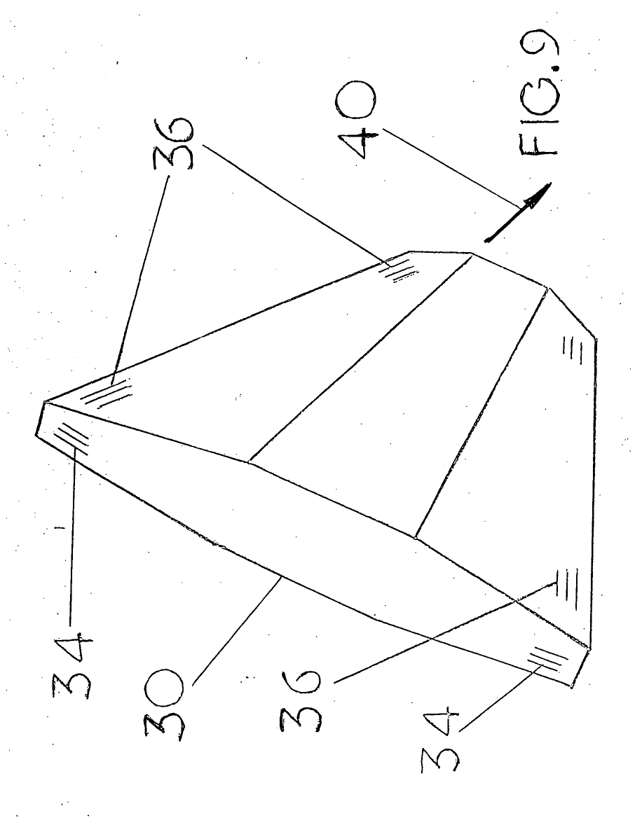

FIG. 9 Is merely illustrative, as there are numerous variations and modifications which maybe made throughout the description. FIG. 9 is a basic example, bottom and end perspective view of a vehicle 30. The view depicts two exhaust propellant forward thrust ports 34, the vehicle 30 may have only one exhaust propellant forward thrust port 34, or no exhaust propellant thrust ports 34. An example of the vehicle 30 with no exhaust propellant forward thrust ports, would be thrust, without the ejection of the propellant 22. The view also depicts four exhaust propellant roll pitch and hovering ports 36. The vehicle 30 may have two exhaust propellant roll pitch and hovering ports 36 or no roll pitch exhaust propellant ports 36. An example of the vehicle 30 with no exhaust propellant roll pitch hovering ports 36, would be thrust, without the ejection of propellant 22. The exhaust propellant roll pitch and hovering port 36 maybe, but is not necessarily placed in the vehicle's 30 structure in conjunction with the propellant 22 flow direction 24-A FIG. 1.

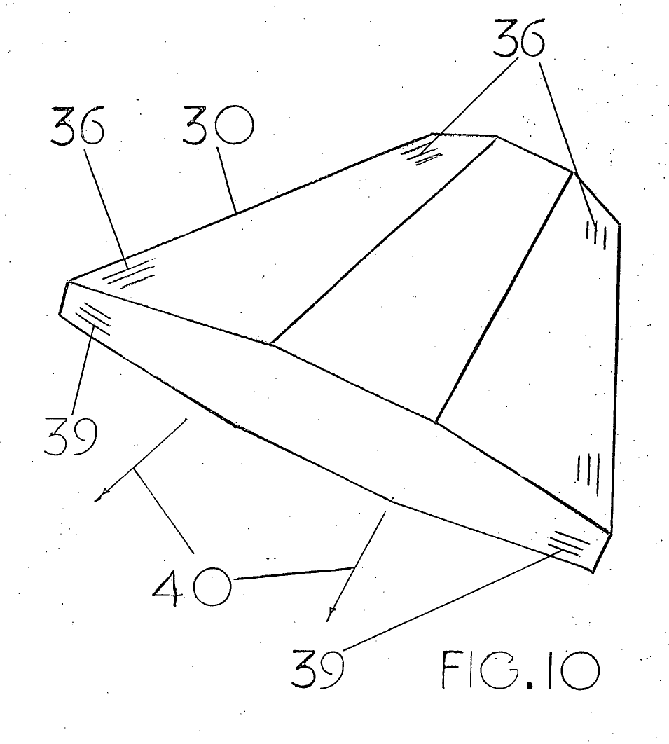

FIG. 10 is merely illustrative, as there are numerous variations and modifications that maybe made throughout the description. FIG. 10 is a basic example, top and front perspective view of a vehicle 30. The view depicts two exhaust propellant aft thrust ports 39. The vehicle 30 may have only one exhaust propellant aft thrust port 39, or no exhaust propellant aft thrust ports 39. An example of the vehicle 30 with no exhaust propellant aft thrust ports, would be thrust without the ejection of propellant 22. The view also depicts four exhaust propellant roll, pitch and hovering ports 36. The vehicle 30 maybe have two exhaust propellant roll, pitch and hovering ports 36, or no exhaust propellant roll pitch and hovering ports 36. An example of the vehicle 30 with no exhaust propellant roll pitch and hovering ports 36 would be thrust without the ejection of propellant 32. The exhaust propellant aft thrusts port 39 maybe, but is not necessarily placed in the vehicle's 30 structure in conjunction with the propellant 22 flow direction 24-A in FIG. 1.

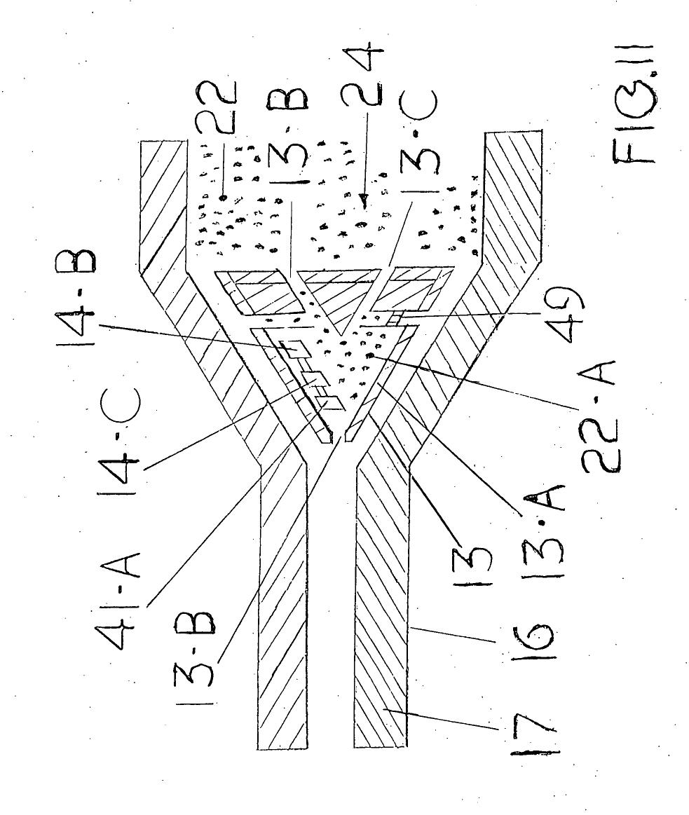

FIG. 11 is merely illustrative, as there are numerous variations and modifications that maybe made throughout the description. FIG. 11 is a basic example partial cross sectional view of a self-supporting levitating mass 13. The self-supporting levitating mass 13 could be but not necessarily designed in a circular configuration. The self-supporting levitating mass 13 reside within the hollow passageway 16 at predetermined locations to gain the most favorable results in affecting the vehicle's 30 transition. The self-supporting levitating mass 13 comprise the composition 13-A repulsive to the maximum and the minimum thermal range of accumulative propellant 22 pressure trapped between it, the hollow passageway 16 and the propellant producing engine 27 FIG. 4. The self-supporting levitating mass 13 also comprise the composition 13-A to oppose the maximum propulsive pressure of accumulated propellant 22 trapped between it, the hollow passageway 16 and the propellant producing engine 27 FIG. 4. The self-supporting levitating mass 13 levitate or hover in a contact less manner within the hollow passage-way 16 at predetermined locations. The self-supporting levitating mass 13 also comprise the composition of propellant 22-A, which reside within the self-supporting levitating mass structure. The self-supporting levitating mass 13 included channels 16-B with in its structure to direct propellant 22-A toward mass exhaust ports 13-C. The mass exhaust ports 13-C are strategically placed on each sides or equal calculated positions on a circumference, of the self-supporting levitating mass 13 to release propellant 22-A. The stationary position and contact less manner of the self-supporting levitating mass 13 is achieved by variant amounts of propellant 22-A being released at selected mass exhaust ports 13-C locations, to oppose propellant 22 pressure, produced by propellant producing engine 27.

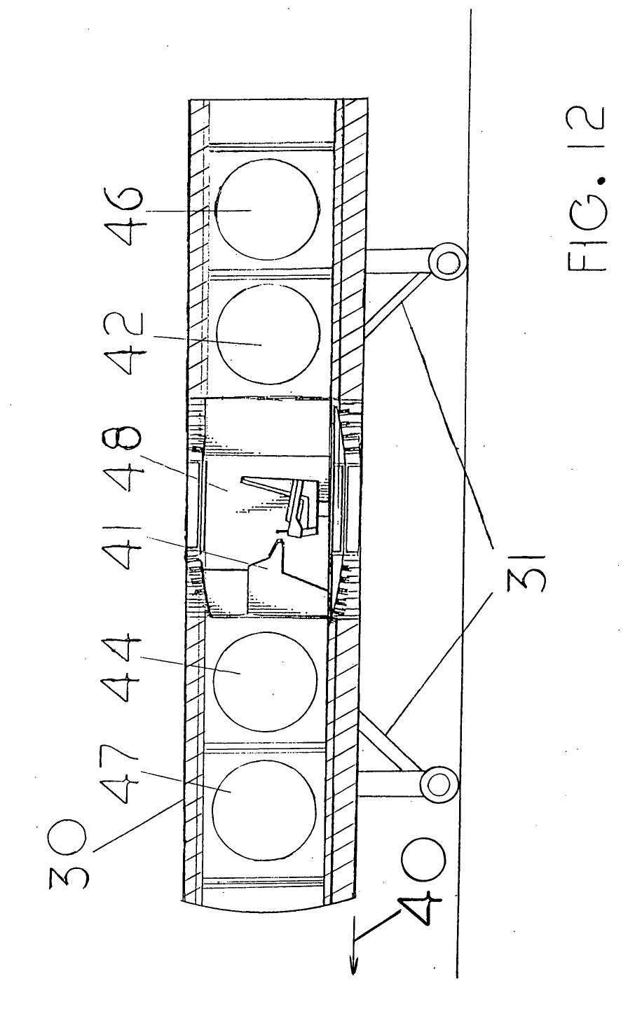

FIG. 12 Is merely illustrative, as there are numerous variations and modifications that maybe made throughout the description. FIG. 12 is a basic example, diagrammatic sectional view, with portions of the hull 30 removed so as to expose the computer control system 41 for the electromagnet 14, this computer control system controls the levitating forces 19 toward the levitating mass 12. The computer control system 41 activate, energize and govern the magnetic field energies 19 flowing from the electromagnet 14 through the hollow passageway 17. The computer control system 41 designates the influence of the propellant gate 26 position and obstruction there by governing the flow of propellant 22 toward the levitating mass 12. The computer control system 41 activate, energize and govern the propellant producing engine 27, which influenced the amount of propellant released toward the levitating mass 12. The computer control system 41 dictates the vehicle's 30 movement in a forward direction, rearward or aft direction, a hovering position, and control around the yaw pitch and roll axis. The view additionally reveals vehicle's 30 supporting system 42 such as hydraulics 43, which may lower and raise the vehicle's 30 weight supporting apparatus 31, pneumatics 42 which may influence propellant gate 26 life supporting systems 47 such as oxygen which may supply oxygen to the crew, and energy source 44, for the electromagnet 14 and payload 46.

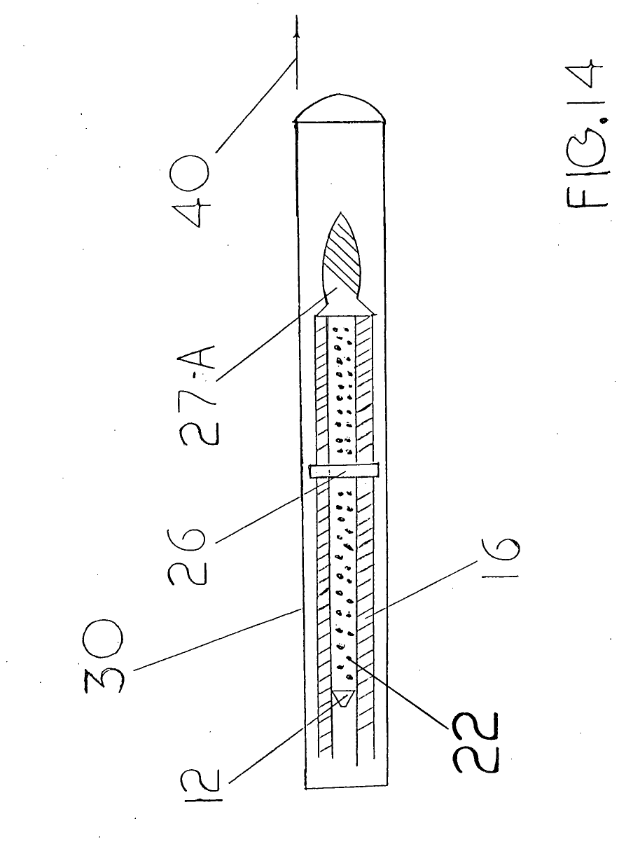

FIG. 14 is merely illustrative, as there are numerous variations and modifications that maybe be made throughout the description. FIG. 14 is a basic example, partial side cross sectional view of propellant 22 under pressure, repelling forward off the levitating mass 12 within the vehicle's 30 structure. The view also depicts the propellant producing engine 27 which produces the produces the propellant, the hollow passageway 16 which direct the propellant 22 toward the levitating mass 12, the propellant gate 26 which obstructs the flow of propellant 22 toward the levitating mass 12 the levitating mass which repels the propellant 22, back toward the propellant producing engine 27.

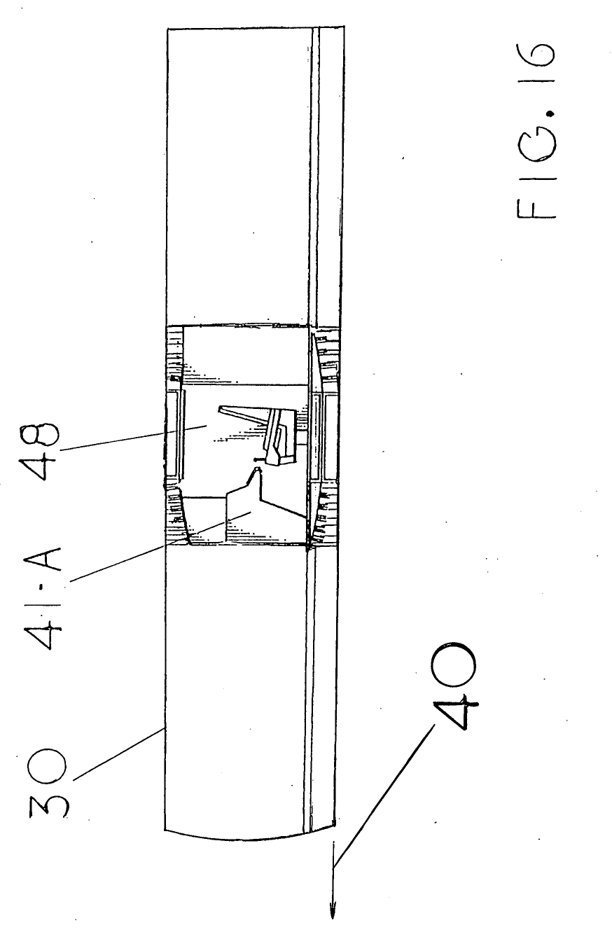

FIG. 16 is merely illustrative, as there are numerous variations and modifications that maybe made throughout the descriptions. FIG. 16 is a basics example, partial side cross section view with portions of the hull 30 removed so as to expose the remote control computer control system 41-A within the vehicle's 30 structure for the self-supporting levitating mass 13. This remote control computer control system 41-A remotely controls the self-supporting levitating mass 13, by providing a signal to the computer circuit control system located within the self-supporting levitating mass which dictate, the amount of propellant 22-A flow, exiting selected mass exhaust ports 13-C to maintain the self-supporting levitating mass stationary position and contact less matter. The view also depicts the crew compartment 48 within the vehicle' 30 structure, for seating and moving over a surface.

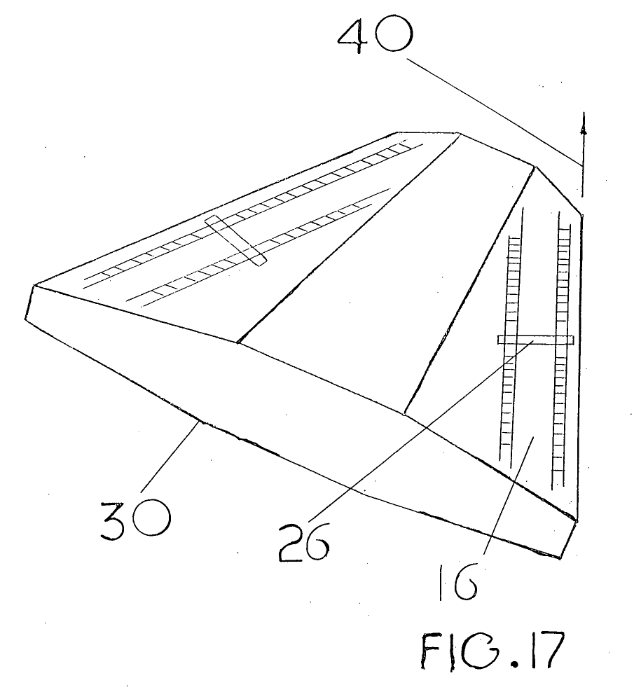

FIG. 17 is merely illustrative, as there are numerous variations and modifications that maybe made thoughout the description. FIG. 17 is a basic example partial top cross sectional view depicting the hollow passage-way 16 and propellant gates 26 within the vehicle's 30 structure. The hollow passage-way 16 reside within the vehicle's 30 structure to direct propellant 22 toward the propellant gates and levitating masses 12. The propellant gates 26 impede movement of propellant 22 and can completely obstruct the flow of propellant 22 toward the levitating masses 12 therefore inducing vehicle's 30 movement in a forward direction, in a rearward or aft direction, a hovering positing, or control in the yaw, roll and pitch axis.

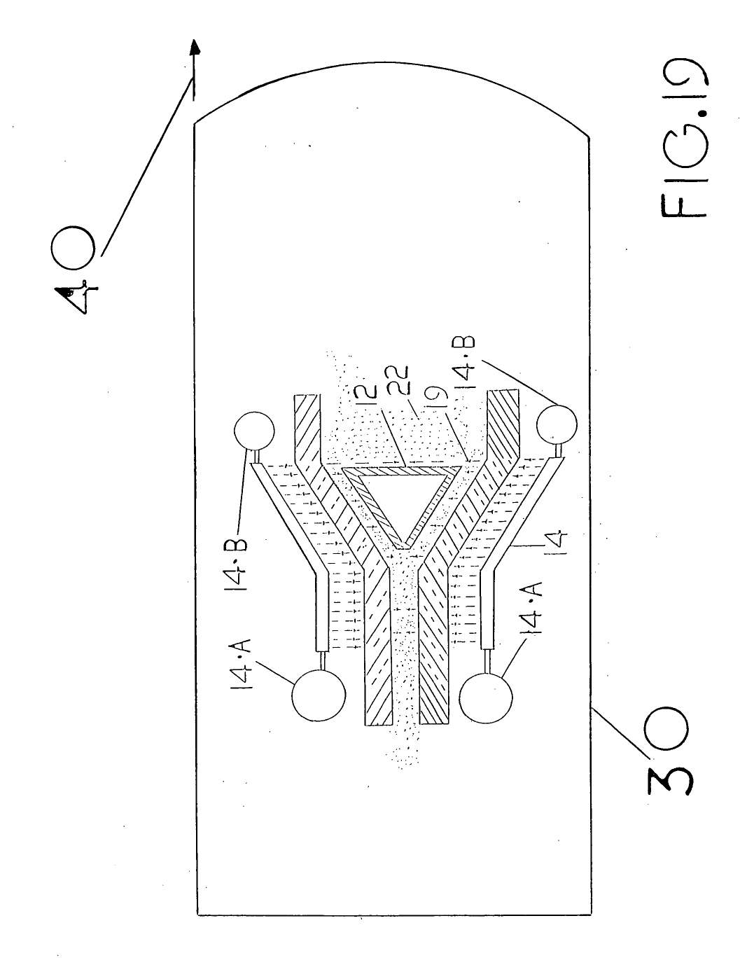

FIG. 19 is merely illustrative, as there are numerous variation and modification that may be made throughout the description within the vehicle's structure. FIG. 19 is a basic example partial cross sectional view depicting the electromagnet 14, the transformer 14-A the variable electronic detector 14-B within the vehicle's 30 structure. The electromagnet 14 converts input energy of one form electricity into output energy, magnetic field energies 19. The magnetic field energies 19 radiate within a 360° circle through the hallow passageway 20, these magnetic field energies 19 attract the levitating mass 12 within a 360° circumference thereby maintaining a stationary position and contact less manner for the levitating mass 12. The variable magnetic detector 14-B provides a signal to the computer control system 41 to fluctuate electrical current flowing through the electromagnet 14, so that the displacement and positioning of the levitating mass 12 remains in a stationary and contact less manner. The transformer 14-A provides high and low levels of electrical energy to the electromagnet 14. These high and low electrical energies fluctuate the magnetic field energies 19 to compensate the propellant pressure pushing against the inner surface of the levitating massl 2.

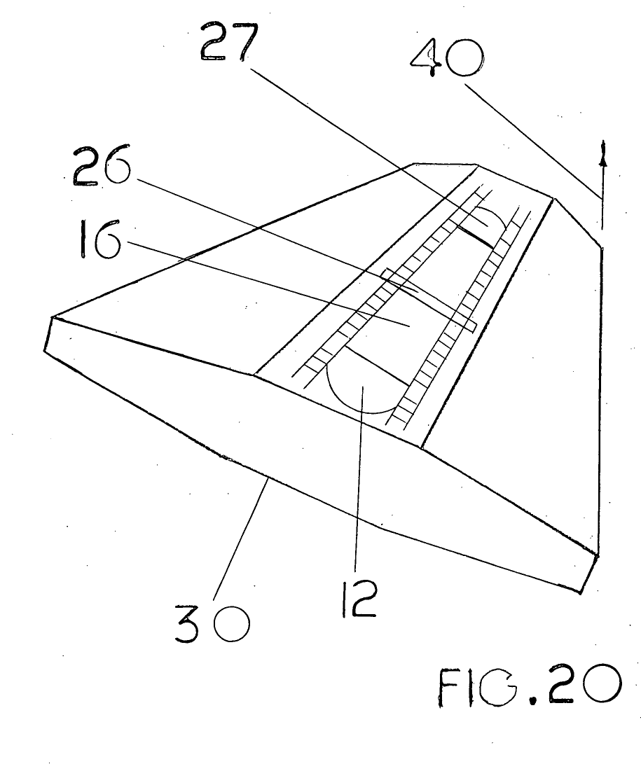

FIG. 20 is merely illustrative, as there are numerous variations and modifications that may be made throughout the description. FIG. 20 is a basic example, partial top cross sectional view depicting one propellant producing engine 27, one hollow passageway 16, one propellant gate 26, and one levitating mass 12, within the vehicle's 30 structure. The propellant producing engine 27, produce the propellant 22 and expel it through the hollow passageway 16 toward the propellant gate 26 and levitating mass 12. The hollow passageway 16, direct the propellant 22, toward the propellant gate 26, and levitating mass 12. The position and layout of the hollow passageway 16 within the vehicle's 30 structure is determined by the direction the vehicle 30 is propelled. The propellant gate 26 regulate the flow of propellant 22 or completely impede the flow of propellant 22 toward the levitating mass 12. The levitating mass 12 hover in a contact less manner within the hollow passageway 16 and obstruct the flow of propellant 22 from leaving the vehicle 30. the levitating mass 12 repel the mass of propellant 22 and propellant pressure 22 back toward the propellant producing engine 27.

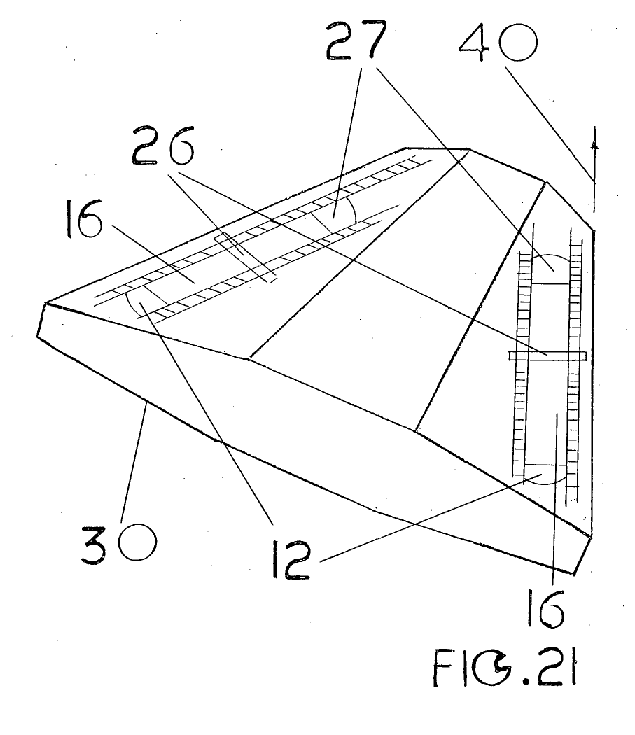

FIG. 21 is merely illustrative, as there are numerous variations and modifications that may be made throughout the descriptions. FIG. 21 is a basic example partial top cross sectional view within the vehicle's 30 structure of more than one propellant producing engine 27, more than one hollow passageway 16, more than one propellant gate 26, and more than on levitating mass 12. The propellant producing engine 27 produce the propellant 22 and expel it through the hollow passage-way 16 toward the propellant gates 26 and levitating masses 12. The hollow passage-way 16 direct the propellant 22 toward the propellant gates 26 and levitating masses 12. The position and layout of the hollow passage-way 16 within the vehicle's structure 30 is determined by the direction the vehicle 30 is propelled. The propellant gates 26 regulate the flow of propellant 22 or completely impede the flow of propellant 22 toward the levitating masses 12. The levitating masses 12 hover in a contact less manner within the hollow passage-way 16 and obstruct the flow of propellant 22 from leaving the vehicle 30. The levitating masses 12 repel the mass of propellant 22 and propellant pressure 22 back toward the propellant producing engines 27.

Operation

In operation the levitating mass 12 are held suspended in space by the magnetic field energies 19 produced by the electromagnet 14. The obstruction to the ejection of propellant 22 accumulates propellant 22 pressure against the engine 27, engine parts, the hollow passage-way 16, propellant gate 26 and the levitating mass 12, thus propelling the engine 27 and the vehicle 30 in which it is mounted. The levitating mass 12 reside inside the hollow passageway 16 at predetermined locations to gain the most favorable results toward the vehicle's 30 direction, attitude, stability and stationary strength. In operation the electromagnet 14 produced transparent magnetic field energies 19 which transmit through the composition 20 of the hollow passageway 16 in FIG. 1 and FIG. 2. The electromagnet 14 could be, but is not necessarily designed for a human controllable input, never the less, a computer might control the degree of magnetic field energies 19 induced on to the levitating mass 12. The electromagnet 14 could be but is not necessarily designed to move back and forth, physically, with the hollow passage-way 16 composition 20 in FIG. 1 and FIG. 2. These movements may position the levitating mass 12 external contoured surface 12-A practically flush against the internal contoured surface of the hollow passageway 16-A. These positions would impede or completely obstruct the flow of propellant 22 past the levitating mass 12. FIG. 2 the electromagnet 14 is designed to transmit transparent magnetic field energies 19 that would hover the levitating mass 12 external contoured surface 12-A practically flush against the internal contoured surface 16-A of the hollow passageway 16. These positions would completely obstruct the flow of propellant 22 past the levitating mass 12 FIG. 2. The electromagnet 14 suspends the levitating mass 12 in space by magnetic field energies 19 which may allow a minute amount of propellant 22 to pass 24-A the levitating mass 12 FIG. 1. The magnetic field energies 19 strengths could be, but not necessarily fluctuate in accordance with propellant 22 propulsive pressure or propellant pounds of thrust. The hollow passageway FIG. 1, FIG. 2, FIG. 3, FIG. 4 reside within vehicle's 30 structure at predetermined locations and arrangements. The placement of the hollow passageway 16 are arranged to facilitate the movement of propellant 22 toward the vehicle's 30 direction, stability, attitude and stationary strength. The propellant gate 26 are strategically positioned in the hollow passageway 16 to gain the most favorable results of the propulsive accumulative propellant 22 trapped in the corresponding hollow passage-way 16 and corresponding propellant gate 26 arrangements. The propellant gates 26 are also strategically positioned in the hollow passage-way 16 to gain the most favorable results toward the vehicle 30 direction, attitude, stability and stationary strength. The propellant gate 26 may impede or completely obstruct the flow of propellant toward the levitating mass 12. The propellant gates 26 control system 41 maybe regulated though and electrical pneumatic or hydraulic arrangements with redundant qualities. An example of a propellant gate 26 is depicted in FIG. 3. The propellant producing engine 27 produce propellant 22 and force it through the hollow passage-way 16 toward the levitating mass 12. The propellant producing engine 27 maybe but are not necessarily in the vehicle's 30 structure to gain the most favorable results of propellant 22 flowing through the hollow passageway 16 toward the levitating mass 12. The propellant producing engine 27 maybe but are not necessarily placed in the vehicle's 30 structure to gain the most favorable results towards the vehicle's 30 direction, attitude, stability and stationary strength. The propellant producing engine 27 control system 41 maybe regulated through an electrical, pneumatic or hydraulic arrangement with redundant qualities to regulate the propellant 22 pressure through the hollow passageway 16, toward the levitating mass 12. An example of the propellant producing engine 27 depicted in FIG. 4. FIG. 5, FIG. 6, FIG. 6, FIG. 7, FIG. 9 and FIG. 10 depict exhaust propellant ports on vehicle 30 numeral 32, 34, 36, 39.The exhaust propellant ports merely eject a minute amount of propellant 22 and have little or no effect on the vehicle 30 direction, attitude, stability and stationary strength. In the event a vehicle 30 is designed with thrust without the ejection of propellant 22 these exhaust ports may not be needed at all. The following descriptions are an example of the vehicle 30 that is designed to travel through outer space. The propellant gate 26 in FIG. 3 will be referred to as a propellant gate or propellant gates within the ensuing descriptions, since no propellant gates are pictures in FIG. 7.9.10. The propellant producing engine 27 would be the liquid fuel rocket engine 27-B in FIG. 4. To lift and hover the vehicle 30 from the earth's surface propellant gates in conjunction with the four exhaust propellant roll, pitch and hovering ports 36 located on the bottom of the vehicle 30 in FIG. 9 are open. The majority of propellant pressures would be channeled to these four levitating masses 12 respectfully. This flight control input raises the vehicle 30 in a vertical trajectory. In this sequence of events, all other propellant gates are feathered in conjunction with all other exhaust propellant ports 32, 34, 36, and 39 to gain the vehicle's 30 most favorable results toward stability and stationary strength. In transition to raise the nose of the vehicle 30, the propellant gates in conjunction with the rear two exhaust propellant roll, pitch, and hovering ports 36 on the bottom side of the vehicle 30 FIG. 9 might be slightly or completely closed and the propellant gates in conjunction with the front two exhaust propellant roll, pitch and hovering ports 36 on the top side of the vehicle 30 FIG. 7 and FIG. 10 maybe closed. Also the propellant gates in conjunction with the two rear exhaust propellant roll, pitch, and hovering ports 36 on the top of the vehicle 30 FIG. 7 and FIG. 10 are open. This flight control input pushes the aft section of the vehicle 30 down, and the propellant gates in conjunction with the two exhaust propellant front roll, pitch and hovering ports 36 on the bottom side of the vehicle 30 FIG. 9 are open. This flight control input pushes the forward section of the vehicle 30 up on the pitch axis. In this sequence of events all other propellant gates are feathered in conjunction with all other exhaust propellant ports 32, 34, and 39 to gain the vehicle's 30 most favorable results in attitude and stability. To lover the nose of the vehicle 30 the propellant gates in conjunction with the rear two exhaust propellant roll, pitch and hovering ports 36 on the top side of the vehicle 30 in FIG. 7 and FIG. 10 maybe closed or slightly closed and the propellant gates in conjunction with the front two exhaust propellant roll, pitch and hovering ports 36 located on the bottom side of the vehicle 30 in FIG. 9 are closed or slightly closed to continue, the propellant gates in conjunction with the two rear exhaust propellant, roll, pitch and hovering ports 36 on the bottom side of the vehicle 30 in FIG. 9 are open, this flight control input pushing the aft section of the vehicle 30 up along the pitch axis, also the propellant gates in conjunction with the two front exhaust propellant roll, pitch and hovering ports 36 on top of the vehicle 30, FIG. 7 and FIG. 10 are open. This flight control input pushes the forward section of the vehicle 30 down along the pitch axis. In this sequence of events, all other propellant gates maybe feathered in conjunction with all other remaining exhaust propellant ports 32, 34 and 39 to gain the vehicle 30 most favorable results. To move the vehicle 30 in a forward direction, the propellant gates in conjunction with the exhaust propellant aft thrust ports 39 FIG. 10 are closed at the front of the vehicle 30. The propellant gates in conjunction with the two exhaust propellant forward thrust ports 34 located at the stem of the vehicle 30 FIG. 7and FIG. 9 are open. The majority of propellant 22 pressure would be channeled to these levitating masses 12. respectfully, which propel the vehicle 30 in a forward direction. In this sequence of events, all other propellant gates may be feathered in conjunction with all other remaining exhaust propellant ports 32 and 36 to gain the vehicle 30 most favorable results in attitude and stability. To make the vehicle 30 roll to the left, propellant gates in conjunction with the two exhaust propellant roll, pitch, and hovering ports 36 on the top starboard side or right side of the vehicle 30 FIG. 7 and FIG. 10, and the propellant gates in conjunction with the two exhaust propellant roll, pitch, and hovering ports 36 on the bottom, portside or left side of the vehicle 30 FIG. 9 are closed. To continue the propellant gates in conjunction with the two exhaust propellant roll, pitch and hovering ports 36 on the top port side or left side of the vehicle 30 FIG. 7 and FIG. 10 are open. This flight control input pushed the top port side or left side of the vehicle 30 down, along the roll axis. Also, the propellant gates in conjunction with the two exhaust propellant roll, pitch and hovering ports 36 on the bottom starboard or right side of the vehicle FIG. 9 are open. This flight control input pushes the bottom starboard or right side of the vehicle 30 up along the roll axis. In this sequence of events, all other propellant gates maybe closed feathered or maintained in conjunction with all other remaining exhaust propellant ports 39, 32, 34 to gain the vehicle's 30 most favorable results in attitude stability and direction. To make the vehicle yaw to the left, the propellant gate for the single exhaust propellant yaw port 32 on the starboard or right side of the vehicle 30 at the rear in FIG. 5 will be closed, and the propellant gate for the single exhaust propellant yaw port 32 on the port or left side of the vehicle 30 at the front FIG. 6 would be closed. To continue the propellant gate for the single exhaust propellant yaw port 32 on the starboard or right side of the vehicle 30 at the front in FIG. 5 would be open. This flight control input would push the front starboard or right side of the vehicle 30 to the left on the yaw axis. Also, The propellant gate for the single exhaust propellant yaw port 32 on the port or left side of the vehicle 30 at the rear in FIG. 6 would be open. This flight control input would push the rear port or left side of the vehicle 30 to the right on the yaw axis. In this sequence of events all other propellant gates may be closed, feathered or maintained in conjunction with all other remaining exhaust propellant ports, 34, 36, 39 to gain the vehicle 30 most favorable results in attitude, stability and direction. To make the vehicle 30 roll to the right propellant gates in conjunction with the two propellant roll, pitch and hovering ports 36 on the top port side or left side of the vehicle 30 FIG. 7 and FIG. 10 and the propellant gates in conjunction with the two propellant roll, pitch and hovering ports 36 on the bottom starboard or right side of the vehicle 30 FIG. 9 are closed. To continue, the propellant gates in conjunction with the two exhaust propellant pitch, roll, and hovering ports 36 on the top starboard or right side or the vehicle 30 FIG. 7 and FIG. 10 are open. This flight control input pushes the top starboard or right side of the vehicle 30 down along the roll axis. Also, the propellant gates in conjunction with the two exhaust propellant roll, pitch, and hovering ports 36 on the bottom port side or left side of the vehicle 30, FIG. 9 are open. This flight control input pushes the bottom port or the left side of the vehicle 30 up along the roll axis. In this sequence of events all other propellant gates may be closed, feathered or maintained in conjunction with all other remaining exhaust propellant ports, 32, 34, 39, to gain the vehicle's 30 most favorable results in attitude, stability, and direction. To make the vehicle 30 yaw to the right the propellant gate for the single exhaust propellant yaw port on the starboard or right side of the vehicle 30 at the front in FIG. 5 would be closed, and the propellant gate for the single exhaust propellant yaw port on the port or left side of the vehicle 30 at the rear in FIG. 6 would be closed. To continue the single exhaust propellant yaw port on the starboard or right side of the vehicle 30 at the rear in FIG. 5 would be open. This flight control input would push the rear portion starboard or right side of the vehicle 30 to the left along the yaw axis. Also, The propellant gate for the single exhaust propellant yaw port on the port or left side of the vehicle 30 at the front in FIG. 6 would be open. This flight control input would push the front portion, port or left side of the vehicle 30 to the right along the yaw axis. In this sequence of events, all other propellant gates may be closed, feathered or maintained in conjunction with all the remaining exhaust propellant ports 34, 36 and 39 to gain the vehicle's 30 most favorable results in attitude, stability and direction. To slow the vehicle 30 down from a forward flight or direction the propellant gates in conjunction with the two exhaust propellant forward thrust ports located at the stem of the vehicle FIG. 7 and FIG. 9 are closed the propellant gates in conjunction with exhaust propellant aft thrust ports 39 located at the front of the vehicle 30 in FIG. 10 are open. The majority of propellant 22 would be channeled to these levitating masses 12 respectively which will slow the vehicle's 30 forward direction and would eventually bring the vehicle 30 to a halt. In this sequence of events all other propelling gates may be feathered in conjunction with all other remaining exhaust propellants ports 33 and 36 to gain the vehicle's 30 most favorable results in attitude and stability.

Reference Numerals in Drawings

12. levitating mass
12-A mating external contoured surface of levitating mass
12-B composition of levitating mass
13 self-supporting levitating mass
13-A composition of self-supporting levitating mass
13-B channels for propellant for self-supporting levitating mass
13-C mass exhaust ports
14 electromagnet
14-a transformer for electromagnet
14-B variable electronic detector for levitating mass
14-C integrator
16 hollow passage-way
16-A mating internal contoured surface of hollow passage-way
16-B propellant channels
17 composition of hollow passage-way
19 arrows represent direction of magnetic lines of force
20 magnetic transparent composition of hollow passageway
22 small dots represent propellant
22-A represents propellant stored in self-supporting levitating mass
23 arrows represent flow direction of propellant
24-A arrows represent propellant flow direction past levitating mass
26 represents propellant gate
27 represents propellant producing engine
27-A depicts solid rocket engine
27-B depicts liquid fuel rocket engine
27-C depicts jet engine
30 represents hull, or vehicle
31 vehicle's weight supporting apparatus
32 represents vehicle's propellant exhaust yaw ports
34 represents vehicle's propellant exhaust forward thrust ports
36 represents vehicle's propellant exhaust pitch, roll, and hovering ports
39 represents vehicle's propellant exhaust aft or rearward thrust ports
40 arrow represents forward direction of vehicle
41 computer control system
41-A remote control computer control system for self-supporting levitating mass
42 vehicle's supporting systems, pneumatics, hydraulics
44 energies source for electromagnet
46 payload
47 life-supporting system
48 crew compartment
49 propellant channel gates

Having thus exposed to view a particular account of a procedure and device, it being perceived that the revelation herein is a model of material form that are not necessarily limiting the range of protection afforded here by.

1. A method of producing thrust in a vehicle with or without the ejection propellant comprising the steps of:
Levitating an arrangement of masses or levitating a mass within the vehicle's structure suspended in place in a contact less manner by magnetic field energies, generated by an electromagnet;
Levitating an arrangement of self-supporting levitating masses or levitating a self supporting levitating mass in a contact less manner by forces generated and released from within said self-supporting mass from within said vehicle's structure;
A hollow passage-way or hollow passage-ways transparent to said magnetic field energies at selected positions;
A propellant gate or propellant gates to regulate the flow of said propellant or completely impede the flow said propellant;
A selected said propellant which is assigned and designated by said vehicle's application means within said vehicle structure means to house propellant producing engines or a propellant producing engine;
Said vehicle's structure means to house said levitating mass or said levitating masses means to house said hollow passage-way or said hollow passage-ways means to house said propellant gate or said propellant gates means to house said propellant producing engine or said propellant producing engines means to house vehicle's supporting operating systems and means to house said vehicle's computer controls systems therein determining said vehicle's attitude in a forward direction, in a rearward direction, in a hovering position, a control around yaw axis, a control around pitch axis and control around roll axis.

1A. A method of producing thrust, in a vehicle with or without the ejection propellant as claimed in claim 1 wherein:
Said hollow passage-way or said hollow passage-ways reside within said vehicle's structure comprise a composition to oppose the maximum propellant pressure trapped between said levitating mass or said levitating masses said propellant producing engine or said propellant producing engines;
Means for said hollow passage-ways or said hollow passage-way comprise a composition to oppose the maximum and minimum thermal range of accumulated said propellant trapped between said levitating mass or levitating masses said propellant producing engines or said propellant producing engine;
Means for placing said hollow passage-way or said hollow passage-ways in said vehicle's structure to direct movement of said propellant toward said levitating mass or said levitating masses, therefore educing said vehicle's movement in said forward direction in said rearward or aft direction in said hovering position or control in said yaw axis control in said pitch axis control in said roll axis;
Means for placing said hollow passage-way or said hollow passage-ways in said vehicle's structure to direct movement of said propellant toward said levitating mass or said levitating masses and
Means for said hollow passage-way or said hollow passage-ways comprise the composition in a predetermined position, transparent to the said magnetic field energies means to gain the most favorable results toward levitating mass or said levitating masses.

1B. A method of producing thrust in a vehicle with or without the ejection of propellant as claimed in claim 1 wherein:
Means for placing said levitating mass or said levitating masses in said hollow passage-way or said passage-ways which are within said vehicle's structure which provide a impasse to said propellant, produced by said propellant producing engine or said producing engines;
Means for said levitating mass or said levitating masses comprise a composition to oppose the maximum said propellant pressure between said hollow passage-ways or said hollow passage-ways and said propellant producing engine or said propellant producing engines;
Means for said levitating mass or said levitating masses comprise a composition to oppose the maximum and minimum thermal range of accumulated said propellant between said hollow passage-way or said hollow passage-ways and said propellant producing engine or said propellant producing engines;
Means for placing said levitating mass or said levitating masses and said hollow passage-way or said hollow passage-ways therefore inducing said vehicle's movement in said forward direction said rearward or aft direction, in said hovering position, control in said yaw axis control in said pitch axis and control said roll axis and
Means for said levitating mass or said levitating masses which are responsive to said magnetic field energies educed and directed by said electromagnet which provide a suspended stationary position toward said levitating mass or said levitating masses which reside within said hollow passage-way or said hollow passage-ways which reside within said vehicle's structure.

1C. A method of producing thrust in a vehicle with or without the ejecting of propellant as claimed in claim 1 wherein:
Means for said electromagnet to control and to create attraction forces to levitate said levitating mass or said levitating masses at a predetermined position in a contact less manner comprises:
A circular arrangement of said electromagnets to levitate said levitating mass or said levitating masses there between;
A transformer to generate power to said electromagnet;
Variable electronic detectors for providing signals to compensate and fluctuate electrical current flowing through said electromagnets so that the displacement and positioning of said levitating mass remains in a stationary and contact less manner;
Means for placing said electromagnet in a circular arrangement in a predetermined position around the outer perimeter or said hollow passage-way or said hollow passage-ways to gain the most favorable results toward levitating said levitating mass or said levitating masses;
Means to house energy source for said transformer;
Means to house said electromagnet or said electromagnets within said vehicle's structure and
Means to house computer control system for said electromagnet to activate, energize and govern magnetic field energies flowing through said hollow passage-way or said hollow passage-ways toward said levitating mass or said levitating masses.

1D. A method of producing thrust in a vehicle with or without the ejection of propellant as claimed in claim 1 wherein:
Said propellant gate or said propellant gates mounted strategically within said hollow passage-way or within said hollow passage-ways to govern movement of said propellant from said propellant producing engine or said propellant said producing engines toward said levitating mass or said levitating masses within said vehicle's structure;
Means for said propellant gate or said propellant gates comprise a composition to oppose the maximum or minimum thermal range of accumulated said propellant trapped between it and said propellant producing engine or said propellant producing engines and said hollow passage-ways or said hollow passage-ways within said vehicle's structure;
Means for said propellant gate or said propellant gates comprise the composition to oppose the maximum propellant pressure trapped between it and said propellant producing engine or said propellant producing engines said hollow passage-ways or said hollow passage-ways within said vehicle's structure;
Means for said vehicle constructed without said propellant gate;
Means to house said propellant gate or said propellant gates within said vehicle's structure;
Means to house computer controls system within said vehicle's structure therein controlling said propellant gate or said propellant gates positioning, thereby governing the flow of said propellant and
Means for placing said propellant gate or said propellant gates with in said hollow passages way or said hollow passage-way to impede movement of said propellant therefore inducing said vehicle's movement in said forward direction said rearward or aft direction said hovering position said control in yaw axis said control in pitch axis said control in roll axis.

1E. A method of producing thrust in a vehicle with or without the ejection or propellant as claimed in claim 1. wherein:
Means for said propellant producing engine or said propellant producing engines comprise a composition to oppose the maximum or minimum thermal range of accumulated said propellant trapped between it and said levitating mass or said levitating masses, said hollow passage-way or said hollow passage-ways said propellant gate or said propellant gates;
Means for said propellant producing engine or said propellant producing engines comprise the composition to oppose the maximum propellant pressure trapped between it and said levitating mass or said levitating masses said hollow passageway or said passage-way said propellant gate or said propellant gates;
Means to store fuel for said propellant producing engines or said propellant producing engine within said vehicle's structure;
Means to house said propellant producing engines or said propellant producing engine within said vehicle's structure and
Means to house computer control systems within said vehicle's structure therein controlling said propellant producing engine or said producing engines thus controlling said propellant output.

1F. A method of producing thrust in a vehicle with or without the ejection or propellant as claimed in claim 1 wherein:
Levitating and arrangement of said self supporting levitating masses or levitating a said self supporting levitating mass suspended in place in a contact less manner by forces generated and expelled from with in said self supporting levitating mass comprising;
Stored said propellant stored within said self supporting levitating mass;
An arrangement of propellant mass exhaust ports, strategically placed on each side or equal calculated position on a circumference on said self supporting levitating mass means allowing release of said propellant;
Channels constructed within said self supporting levitating mass means to direct stored said propellant toward said propellant mass exhaust ports;
Variable electronic detector for providing signals to compensate said propellant exiting said propellant mass exhaust ports so that the displacement and position or said self supporting levitating mass remains in a stationary and contact less manner;
Integrators for integrating the variable electronic detector circuit signals;
Computers circuit control systems located within said self supporting levitating mass to monitor said variable detector signals and said integrators means to monitor the positioning and contact less manner or said self supporting levitating mass and
Remote control computer control systems, located within said vehicle's structure means to monitor electrical signals from said computer circuit control systems, said integrators and said variable detector circuits means to govern the flow of said propellant exiting said mass exhaust ports to maintain said self supporting levitating mass within stationary position and contact less manner.

2. A method of producing thrust in a vehicle with or without the ejection of propellant as claimed in claim 1 wherein:
Producing said thrust by amassing said propellant pressure between said levitating mass or said levitating masses, said hollow passage-way or said hollow passage-ways, said propellant gate or said propellant gates and said propellant producing engine or said propellant producing engines means to exert a repelling force against said vehicle's structure where said propellant producing engine or said propellant producing engines are mounted;
Producing said thrust by accumulating said propellant between said levitating mass or said levitating masses, said hollow passage-way or said hollow passage-ways, said propellant gate or said propellant gates and said propellant producing engine or said propellant producing engines, exert a repelling force against said vehicle's structure on which said propellant producing engine or said propellant producing engines are mounted and
Producing said thrust through the absence of physical structure members between said levitating mass or said levitating masses and said hollow passage-ways or said hollow passage-way.

3. A method of producing thrust in a vehicle with or without the ejection or propellant as claimed in claim 1 wherein:
Said levitating mass or said levitating masses seat in minute proximity in a contact less manner within a circular configuration around said predetermined inner circumference surface or said hollow passage-ways or said hollow passage-way, hence the application thrust, with or without the ejection of propellant;
Said vehicle constructed with only one said propellant producing engine one said hollow passage-way and one said levitating mass;
Said vehicle constructed with two or more said propellant producing engines, two or more said hollow passage-ways and two or more said levitating masses;
Means to store payload within said vehicle's structure;
An apparatus for supporting said vehicle's weight during launch or rest;
Means to house crew compartment within said vehicle's structure;
Means to house life supporting systems for said crew within said vehicle's structure and
Means to construct said vehicle without a crew compartment within said vehicle's structure.
